(19) United States
(12) Patent Application Publication
(10) Pub. No.: US 2012/0049993 A1
(43) Pub. Date: Mar. 1, 2012

(54) TRANSFORMER INTEGRATED WITH INDUCTOR

(75) Inventors: Kyu Bum HAN, Gyeonggi-do (KR); Seog Moon CHOI, Seoul (KR); Young Ho SON, Gyeonggi-do (KR)

(73) Assignee: SAMSUNG ELECTRO-MECHANICS CO., LTD., Gyunggi-do (KR)

(21) Appl. No.: 13/219,800

(22) Filed: Aug. 29, 2011

(30) Foreign Application Priority Data
Aug. 31, 2010 (KR) 10-2010-0084821

(51) Int. Cl. H01F 27/28

(52) U.S. Cl. 336/220

(57) ABSTRACT

Disclosed herein is a transformer integrated with an inductor. The transformer includes a transformer unit configured to perform voltage transformation by mutual induction between first and second cores connected opposite to each other and primary and secondary coils included in a space between the first core and the second core; and an inductor unit having a third core connected to the second core and an inductor included in a space between the second core and the third core. The transformer is fabricated by physically integrating two elements having different functions into one element, thereby simplifying the configuration of a system.

### CROSS REFERENCE TO RELATED APPLICATION

This application claims the benefit of Korean Patent Application No. 10-2010-0084821, filed on Aug. 31, 2010, entitled “Transformer Integrated with Inductor”, which is hereby incorporated by reference in its entirety into this application.

### BACKGROUND OF THE INVENTION

1. Technical Field

The present invention relates to a transformer integrated with an inductor, and more particularly, to a transformer in which an element for performing the function of a transformer and an element for performing the function of a resonant inductor are physically integrated into one element.

2. Description of the Related Art

Recently, as limits on harmonic current have increased internationally, the usage of a power factor correction circuit in various electric and electronic products have become more commonplace and compulsory. As a result, presently, most of the power supply devices include a power factor correction circuit (PFC) and a direct current to direct current (DC-DC) converter. General power factor correction circuits use a boost converter, wherein the output of the boost converter is always higher than the input thereof due to its characteristic. Furthermore, since the output voltage is again used as the input of the DC-DC converter, the DC-DC converter has a high input voltage.

Meanwhile, in order to fabricate a power supply device as a built-in product having high power density, it is necessary to simplify its structure and reduce its volume. Generally, as a switching frequency is higher, the volume of the power factor correction circuit can be reduced, while switching loss increases in proportion to the switching frequency, thereby reducing efficiency. Therefore, zero voltage switching required for obtaining high efficiency in the power factor correction circuit becomes the requirements. The zero voltage switching is performed using the leak inductance of the transformer and the inductance of an external resonant inductor. That is, the resonant inductor and the transformer perform important roles in a resonant converter structure.

### SUMMARY OF THE INVENTION

An object of the present invention is to provide means for simplifying the configuration of a system.

According to an exemplary embodiment of the present invention, there is provided a transformer integrated with an inductor, including: a transformer unit performing voltage transformation by mutual induction between first and second cores connected opposite to each other and primary and secondary coils included in a space between the first core and the second core; and an inductor unit having a third core connected to the second core and an inductor included in a space between the second core and the third core.

According to another exemplary embodiment of the present invention, there is provided a transformer integrated with an inductor, including: first to third cores connected in sequence; a first bobbin inserted between the first core and the second core and having primary and secondary coils wound thereon in sequence; and a second bobbin inserted between the second core and the third core and having a tertiary coil wound thereon.

### BRIEF DESCRIPTION OF THE DRAWINGS

FIG. 1 illustrates the configuration of a power supply device including a transformer according to an embodiment of the present invention;

FIG. 2 is a cross-sectional view illustrating the transformer of FIG. 1; and

FIG. 3 is a perspective view illustrating the transformer of FIG. 1.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, the detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

The transformer integrated with an inductor according to embodiments of the present invention is described with reference to the accompanying drawings below.

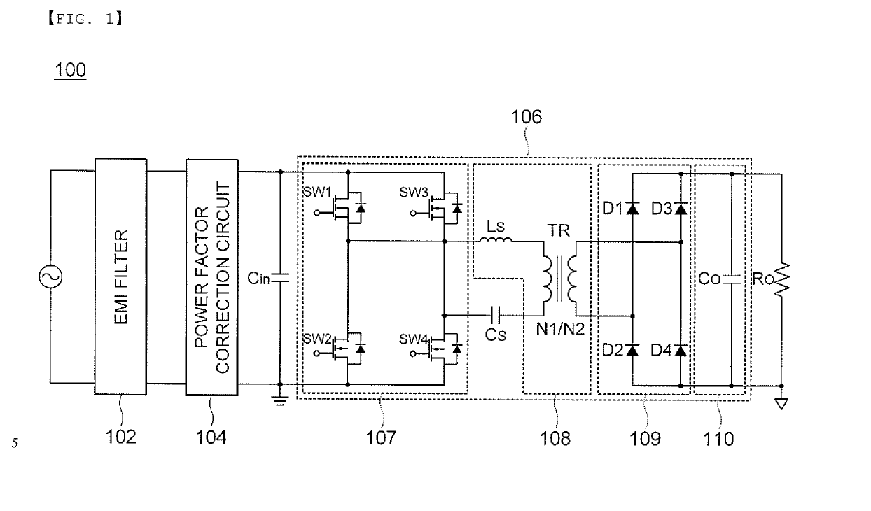

FIG. 1 is a diagram illustrating the configuration of a power supply device including a transformer according to an embodiment of the present invention.

The power supply device 100 according to the embodiment of the present invention includes an EMI filter 102, a power factor correction circuit 104, and a DC-DC converter 106, as illustrated in FIG. 1.

The functions of the respective blocks of the power supply device 100 are described below.

First, the EMI filter 102 eliminates harmonic elements included in alternating-current voltage and outputs it.

Next, the power factor correction circuit (PFC) 104 is circuits for transforming alternating-current voltage into direct-current voltage and outputting it, which reduces noise in current waveform and voltage waveform consisting of the direct-current voltage and increases and outputs a power factor. More particularly, as the distance for power transmission is longer, mismatch between the current waveform and the voltage waveform increases. As an interval in which the current waveform and the voltage waveform are mismatched to each other is broader, the ratio of invalid power to valid power increases, so that the power factor is decreased. The power factor correction circuit 104 increases the interval in which the two waveforms are matched to each other, so that the interval in which valid power can be used increases, thereby increasing the power factor. The direct-current voltage output from the power factor correction circuit 104 is boosted to power having a level suitable to operate internal circuits by the DC-DC converter 106.

The DC-DC converter 106 includes a switching unit 107, a resonant capacitor Cs, a transformer 108, a rectifying unit 109, and a smoothing unit 110.

First, the switching unit 107 includes first to fourth switches SW1˜SW4. The first and fourth switches SW1 and SW4 and the second and third switches SW2 and SW3 are alternately turned on and off at constant time intervals, thereby generating square waves. More particular, when the first and fourth switches SW1 and SW4 or the second and third switches SW2 and SW3 are turned off, the direction of current induced in the primary coils of the transformer 108 is altered due to resonant operations by the resonant inductor Ls and resonant capacitor Cs of the transformer. At this time, voltage across both ends of the first and fourth switches SW1 and SW4 or the second and third switches SW2 and SW3 becomes 0V, and then, in the state of the zero voltage, corresponding switches are turned on, thereby increasing power transformation efficiency. That is, the switching unit 107 performs zero voltage switching (ZVS) using resonance generated by the resonant capacitor Cs and the resonant inductor Ls of the transformer 108, thereby obtaining high power transformation efficiency upon the generation of square waves.

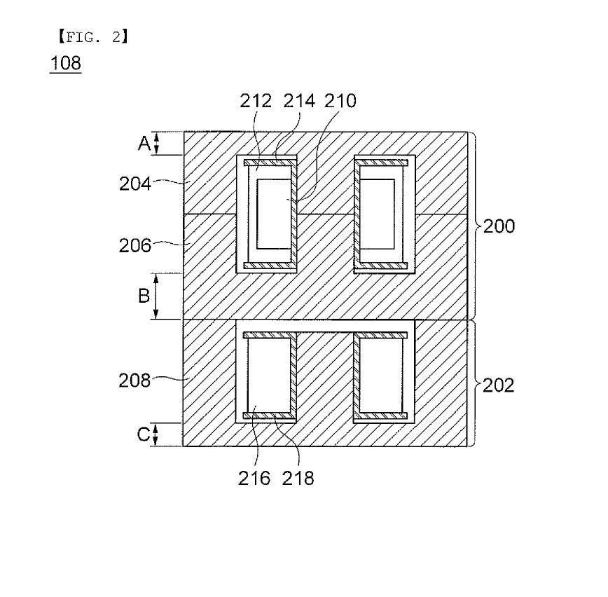

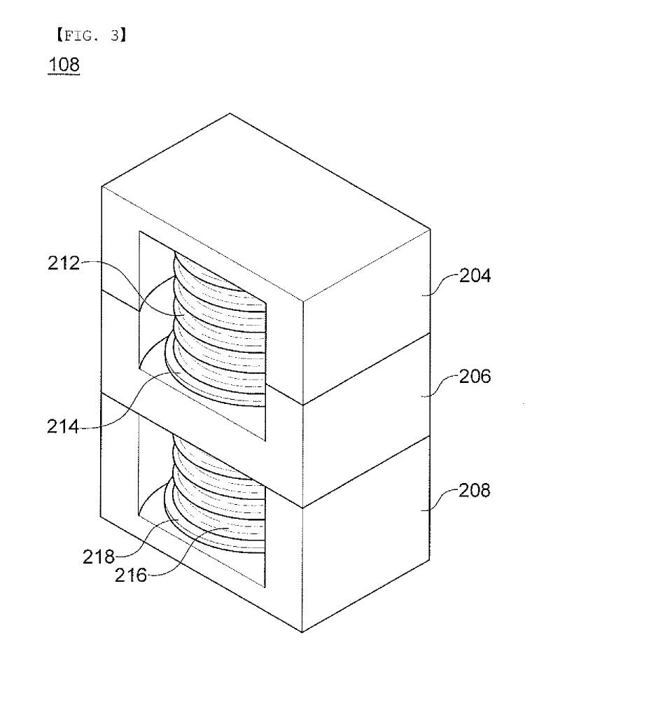

The resonant inductor Ls of the transformer 108 helps the zero voltage switching of the switching unit 107 by performing resonant operation in cooperation with the resonant capacitor Cs, boosts the square waves, that is, alternating current generated by the switching unit 107 to voltage having a constant level using primary and secondary coils and outputs it. Mutual induction occurs between the primary and secondary coils, so that the alternating-current voltage input to the primary coils is transformed to be induced in the secondary coils. The primary coils of the transformer 108 are serially coupled to the resonant inductor Ls and the resonant capacitor Cs, respectively. In the meanwhile, the transformer 108 is fabricated to have a structure physically integrated with the resonant inductor Ls. Details about such a structure are described with reference to FIGS. 2 and 3 below.

Subsequently, the rectifying unit 109 rectifies the alternating-current power boosted by the transformer 108 and the smoothing unit 110 smoothes and outputs direct-current power rectified by the rectifying unit 109.

FIG. 2 is a cross-sectional view illustrating the transformer of FIG. 1, and FIG. 3 is a perspective view illustrating the transformer of FIG. 1.

Referring to FIGS. 2 and 3, the transformer 108 includes a transformer unit 200 and an inductor unit 202.

First, the transformer unit 200 includes a first core 204 and a second core 206 which are coupled opposite to each other and a bobbin 214 which is inserted between the first and second cores 204 and 206 and on which the primary coils 210 and the secondary coils 212 are wound. In this case, the primary coils 210 are first wound on the bobbin 214 and the secondary coils 212 are subsequently wound thereon. The primary coils 210 and the secondary coils 212 are insulated from each other via insulating vinyl. Meanwhile, the inductor unit 202 includes a third core 208 which is connected to the second core 206 of the transformer unit 200 and a bobbin 218 which is inserted between the second core 206 and the third core 208 and on which the coils 216 are wound. In this case, the second core 206 and the third core 208 are connected toward the same direction as each other unlike the first and second cores 204 and 206. In other words, in the transformer 108, the first to the third cores 204, 206 and 208 are connected in sequence, the primary and secondary coils 210 and 212 which perform a voltage transformation function by mutual induction with respect to each other are included between the first core 204 and the second core 206, and the coils 216 which act as the resonant inductor is included between the second core 206 and the third core 208. That is, the spaced distance between the primary and secondary coils 210 and 212 and the coils 216 is determined by the thickness B of the second core 206. Each of the first to the third cores 204, 206 and 208 may include an E-shaped core having the shape of an E as shown in FIGS. 2 and 3.

Meanwhile, since the primary and secondary coils 210 and 212 and the coils 216 are arranged close to each other, the mutual induction therebetween may be problematic. In order to prevent it, the thickness B of the second core 206, which performs a function of physically insulating the primary and secondary coils 210 and 212 from the coils 216, is fabricated to be broader than the thickness A of the first core 204 or the thickness C of the third core 208. In this case, the ratio of respective thicknesses of the first core 24, the second core 206 and the third core 208 is 1:2:1. Of course, it may be possible to further increase the thickness B of the second core 206 in order to provide an enough spaced distance. Meanwhile, the distance between the primary and secondary coils 210 and 212 and the coils 216 can be increased by equalizing the thicknesses A, B and C of the first to the third cores 204, 206 and 208 and additionally inserting an I-shaped core between the second core 206 and the third core 216. In this case, the ratio of 1:2:1 is provided only as an example, so that it may vary depending on the materials, winding numbers, the shapes of the cores or the like of the first to the third cores 204, 206 and 208.

As described above, the transformer integrated with an resonant inductor according to the embodiments of the present invention is fabricated by integrating the element for performing the function of a transformer and the element for performing the function of the resonant inductor into a single element, so that the configuration of a system is simplified and a heat sink becomes monolithic to increase the efficiency of the heat sink.

Furthermore, the spaced distance between two elements is set to be broad enough so that mutual induction that may occur between the two integrated elements can be prevented.

The embodiments of the present invention simplify the configuration of a system by physically integrating two elements respectively having different functions into one element.

Furthermore, the embodiments of the present invention integrate heat sinks that are respectively equipped with two elements into one element by integrating the two elements into one element, thereby efficiently implementing a heat sink.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention should not be limited to the above-described embodiments but should be determined by not only the appended claims but also the equivalents thereof.

1. A transformer, comprising:
a transformer unit performing voltage transformation by mutual induction between first and second cores connected opposite to each other and primary and secondary coils included in a space between the first core and the second core; and
an inductor unit having a third core connected to the second core and an inductor included in a space between the second core and the third core.

2. The transformer according to claim 1, wherein the second and third cores are connected toward the same direction.

3. The transformer according to claim 1, wherein the second core has a thickness set to be broader than thicknesses of the first and third cores.

4. The transformer according to claim 3, wherein a ratio between respective thicknesses of the first, second and third cores is set to be 1:2:1.

5. The transformer according to claim 1, wherein an I-shaped core is additionally connected between the second core and the third core.

6. The transformer according to claim 1, wherein the first to the third cores are E-shaped cores.

7. The transformer according to claim 5, wherein the thicknesses of the first to the third cores are set to be identical to each other.

8. A transformer, comprising:
first to third cores connected in sequence;
a first bobbin inserted between the first core and the second core and having primary and secondary coils wound thereon in sequence; and
a second bobbin inserted between the second core and the third core and having a tertiary coil wound thereon.

9. The transformer according to claim 8, wherein the first core and the second core are connected opposite to each other and the second and third cores are connected toward the same direction.

10. The transformer according to claim 8, wherein the second core has a thickness set to be broader than thicknesses of the first and third cores.

11. The transformer according to claim 10, wherein a ratio between respective thicknesses of the first, second, and third cores is set to be 1:2:1.

12. The transformer according to claim 8, wherein an I-shaped core is additionally connected between the second core and the third core.

13. The transformer according to claim 8, wherein the first to the third cores are E-shaped cores.

14. The transformer according to claim 12, wherein the thicknesses of the first to the third cores are set to be identical to each other.
